(19) United States
(12) Patent Application Publication
(10) Pub. No.: US 2011/0273830 A1
(43) Pub. Date: Nov. 10, 2011

(54) Notebook type information processing apparatus

(75) Inventor: Soichi Tanaka, Kanagawa (JP)

(73) Assignee: Sony Corporation, Tokyo (JP)

(21) Appl. No.: 13/066,614

(22) Filed: Apr. 19, 2011

(30) Foreign Application Priority Data
May 7, 2010 (JP) P2010-106903

(51) Int. Cl. G06F 1/16

(52) U.S. Cl. 361/679.27

(57) ABSTRACT

A notebook type information processing apparatus includes: a main body housing having a substantially rectangular main surface on which an input section is disposed; and a display section having a display panel and formed in a rectangular shape, the display section being lapped over the main surface of the main body housing, the display section covering the input section when lapped over the main body housing with a corner portion thereof disposed inwardly from a corner portion of the main surface to expose the corner portion of the main surface.

### BACKGROUND OF THE INVENTION

1. Field of the Invention

The preset invention relates to a notebook type information processing apparatus including a main body housing and a display section stacked on the main body housing. In particular, the invention relates to such a notebook type information processing apparatus having a feature for protecting the display section.

2. Description of the Related Art

A notebook type information processing apparatus or what is called a notebook type personal computer includes a main body housing having a rectangular shape, a display section lapping over the main body housing, and a hinge mechanism connecting the display section such that it can be turned with respect to the main body housing (for example, see JP-A-2008-288801 (Patent Document 1)). The display section includes a display panel constituted by a liquid crystal display, an organic EL display, or a surface-conduction electron-emitter display.

Recently, there are increasing demands for portable notebook type information apparatus. There are strong demands for smaller and lighter notebook type information processing apparatus for improved portability. Thus, lightweight and easy to carry notebook type information processing apparatus are preferred. The trend toward smaller apparatus has resulted in demands for display sections having smaller thicknesses.

### SUMMARY OF THE INVENTION

The rigidity of a housing of an apparatus main body can be easily improved by providing ribs in the housing. However, it has been difficult to improve the rigidity of a display section by providing ribs because of the need for making the display section thinner. Further, recent notebook type information processing apparatus are intended to be carried around by a user as described above, and the apparatus may therefore be dropped to the ground or the like while they are carried around. Therefore, in the case of a notebook type information processing apparatus according to the related art as disclosed in Patent Document 1, a display section or a display panel incorporated in the display section can be damaged by a strong impact force applied thereto when the apparatus is dropped into collision with the ground or a desk.

In particular, such a force is likely to concentrate at a corner portion of the display section because the corner portion makes a point contact with the ground or desk. Therefore, such a corner portion is a region where a great impact force is likely to act on the display section or the display panel incorporated in the display section. It is therefore required to provide measures against problems which can occur when an apparatus drops to collide with the ground at a corner portion thereof.

In light of the above-described problem, it is desirable to provide a notebook type information processing apparatus which can be prevented from being impacted with a great force at a corner portion of a display section thereof when it is dropped.

According to an embodiment of the invention, there is provided a notebook type information processing apparatus including a main body housing having a substantially rectangular main surface on which an input section is disposed and a display section having a display panel and formed in a rectangular shape, the display section being lapped over the main surface of the main body housing. The display section covers the input section when lapped over the main body housing with a corner portion thereof disposed inwardly from a corner portion of the main surface to expose the corner portion of the main surface.

The notebook type information processing apparatus according to the embodiment of the invention is formed such that a corner portion of the display section is disposed inside a corner portion of the main surface of the main body housing to expose the corner portion of the main body housing. Thus, even when the apparatus is dropped to the ground or a desk, the corner portion of the display section will not collide with the ground or the desk, and collision with the ground or the like takes place at the corner portion of the main surface of the main body housing which is higher in rigidity than the display section. As a result, it is possible to prevent a great impact force from being applied to the display panel provided at the display section, and breakage of the display panel can be prevented.

### BRIEF DESCRIPTION OF THE DRAWINGS

FIG. 1 is a perspective view of a first embodiment of a notebook type information processing apparatus according to the invention;

FIG. 2 is a perspective view of the first embodiment of the notebook type information processing apparatus according to the invention showing the apparatus with a display section thereof closed;

FIG. 3 is a plan view of the first embodiment of the notebook type information processing apparatus according to the invention showing the apparatus with the display section thereof closed;

FIG. 4 is a side view of the first embodiment of the notebook type information processing apparatus according to the invention showing the apparatus with the display section thereof closed;

FIG. 5 is a front view of the first embodiment of the notebook type information processing apparatus according to the invention showing the apparatus with the display section thereof closed;

FIG. 6 is an illustration of a state of the first embodiment of the notebook type information processing apparatus according to the invention observed when the apparatus is dropped to the ground; and

FIG. 7 is a side view of a second embodiment of the notebook type information processing apparatus according to the invention showing the apparatus with a display section thereof closed.

### DESCRIPTION OF PREFERRED EMBODIMENTS

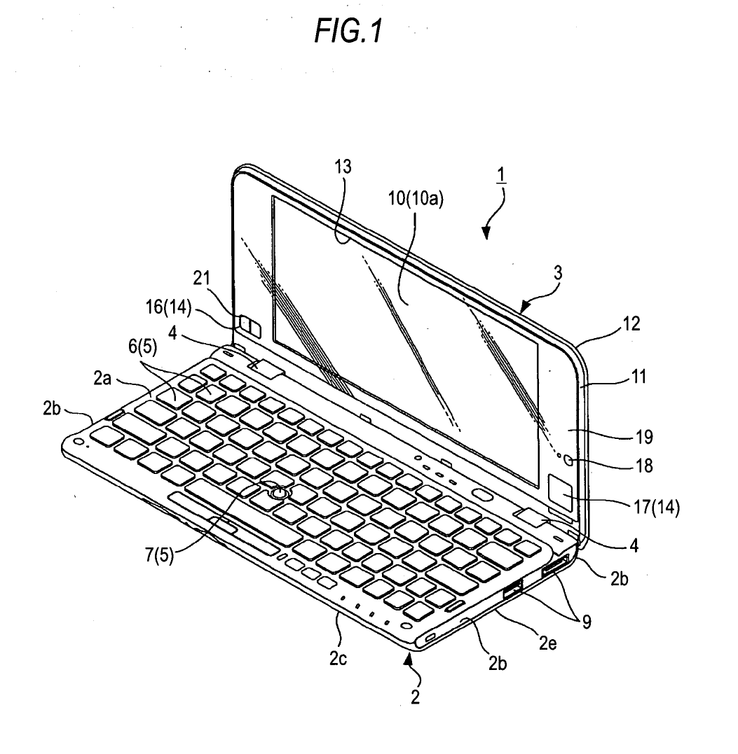

Embodiments of a notebook type information processing apparatus according to the invention will now be described with reference to FIGS. 1 to 7. A member commonly appearing some of the figures will be indicated by like reference numerals. The invention is not limited to the embodiments described below.

Description will be made in the following order.

1. First Embodiment

2. Second Embodiment

### 1. First Embodiment

A first embodiment of a notebook type information processing apparatus according to the invention (hereinafter referred to as “present embodiment”) will be described with reference to FIGS. 1 to 6.

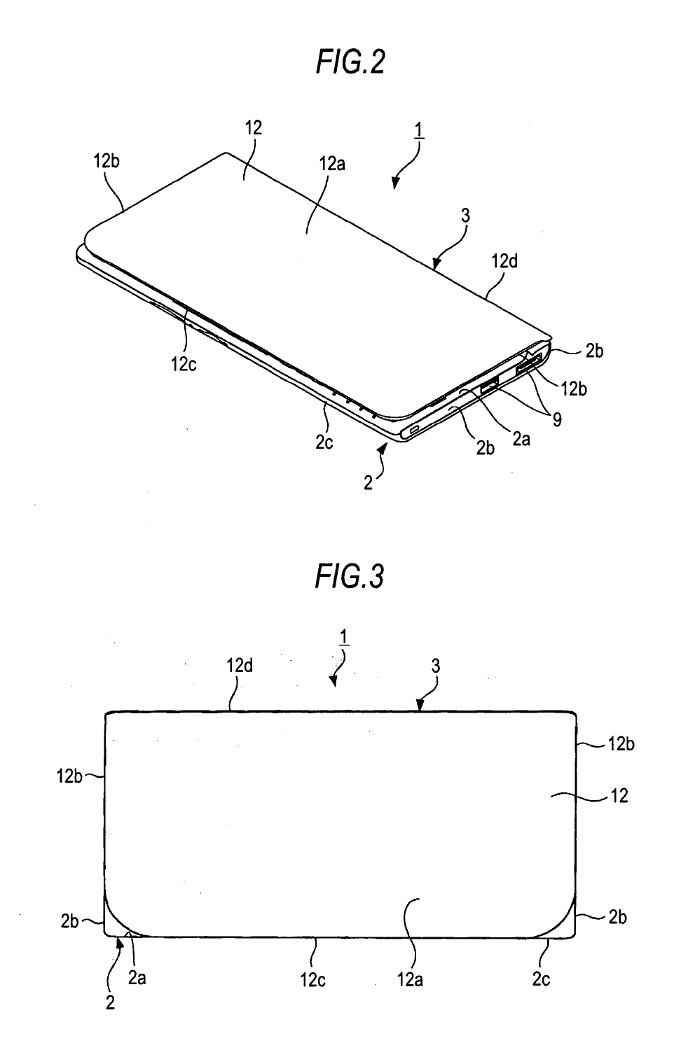

FIG. 1 is a perspective view of the notebook type information processing apparatus of the present embodiment, and FIG. 2 is a perspective view of the notebook type information processing apparatus of the present embodiment showing a state thereof in which a display section is closed.

As shown in FIG. 1, a notebook type information processing apparatus 1 according to the present embodiment is what is called a notebook type personal computer. The notebook type personal computer 1 includes a main body housing 2, a display section 3, and a hinge mechanism 4. The main body housing 2 and the display section 3 are configured such that they can be stacked in an overlapping relationship with each other. The display section 3 is stacked on the main body housing 2, and the main body housing 2 and the display section 3 are connected by the hinge mechanism 4 such that the display section can be turned.

The main body housing 2 is formed in a planar and substantially rectangular parallelepiped shape. A control section and a storage device constituted by a HDD (hard disc drive), a flash SSD (flash solid-state drive) or the like are incorporated in the main body housing 2. The control section is formed by providing predetermined electronic components such as microcomputers, resistors, and capacitors on a wiring substrate.

The main body housing 2 has a substantially rectangular parallelepiped main surface 2a, two side surfaces 2b, a front surface 2c, a rear surface 2d, and a mounting surface 2e. The two side surfaces 2b are formed to be contiguous with two longitudinal ends of the main surface 2a and to extend substantially perpendicular to the main surface. The front surface 2c is disposed at one transversal end of the main surface 2a. The rear surface 2d is disposed at the other transversal end of the main surface 2a opposite to the front surface 2c. The mounting surface 2e is opposite to the main surface 2a.

A first input section 5 is provided on the main surface 2a. The first input section 5 includes a first key input portion 6 constituted by a multiplicity of keys and a stick pointer 7. The stick pointer 7 is disposed in the middle of the main surface 2a. The stick pointer 7 is used for moving a cursor displayed on a display surface of the display section 3 which will be described later and for scrolling a screen. Control signals are input using the first key input portion 6 and the stick pointer 7 to perform predetermined information processing operations.

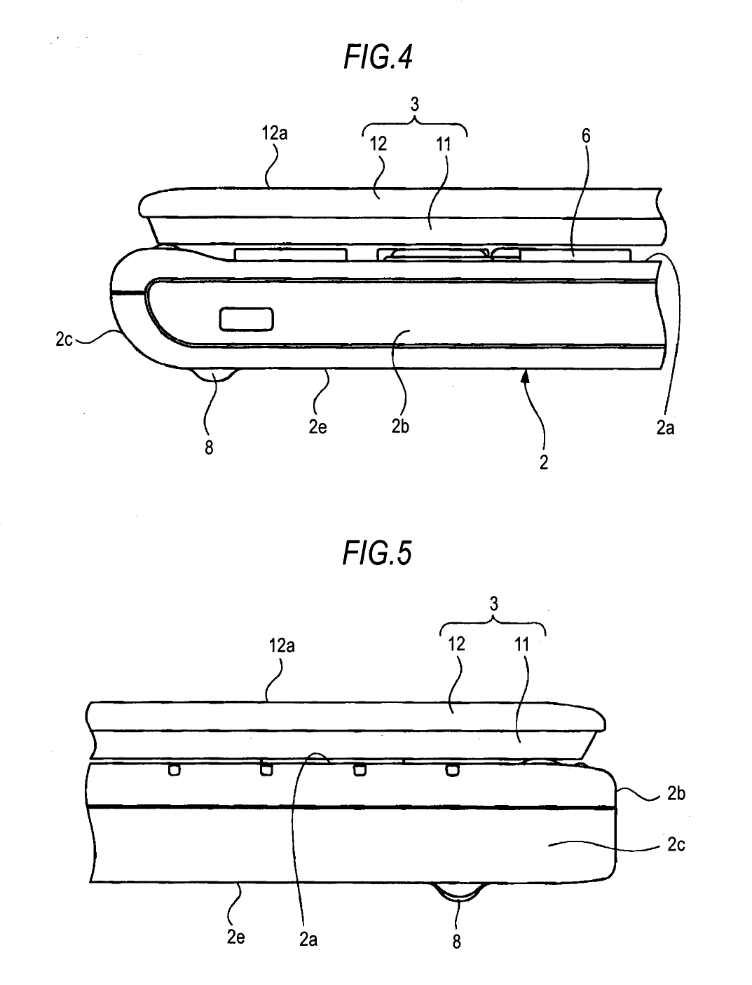

A leg member 8 is provided on the mounting surface 2e opposite to the main surface 2a, the leg member contacting a surface of a desk or the like on which the apparatus is placed to support the main body housing 2 (see FIGS. 4 and 5). The leg member 8 is a protrusion protruding from the mounting surface 2e in the direction opposite to the main surface 2a. Connection terminals 9 for connecting the apparatus with external devices such as an external disc drive and a USB flash memory are provided on a side surface 2b.

Further, the hinge mechanism 4 is provided on left and right sides of the rear surface 2d. As shown in FIGS. 1 and 2, the main body housing 2 and the display section 3 are connected by the hinge mechanism 4 such that the display section can be turned. Thus, the notebook type personal computer 1 is configured such that the display section 3 can be turned upward and downward with respect to the main body housing 2. The hinge mechanism 4 is formed such that the display section 3 can be kept in a tilted attitude in a position at an arbitrary angle to the main body housing 2.

For example, engineering plastic may be used as the material of the main body housing 2 having the above-described configuration.

The display section 3 is formed in a planar and substantially rectangular parallelepiped shape like the main body housing 2. The display section 3 includes a display panel 10, a front plate 11 provided opposite to the main surface 2a of the main body housing 2, and a rear plate 12. Further, a camera is incorporated in the display section 3.

For example, the display panel 10 may be a liquid crystal display panel, an organic EL display, or a surface-conduction electron-emitter display. Although not shown, a backlight for projecting light on the rear side of the display panel 10 and a wiring substrate carrying a controller for controlling a screen of the display panel 10 are housed in the display panel 10 as occasion demands. The display panel 10 is configured to be able to display various types of information and various images.

The front plate 11 is provided in the form of a substantially rectangular flat plate. The front plate 11 has a substantially rectangular opening 13. Further, the display panel 10 is secured to the front plate 11 through a frame member which is not shown. The opening 13 of the front plate 11 exposes a display surface 10a of the display panel 10 mounted in the display section.

A second input section 14 is provided on both sides of the opening 13 of the front plate 11 when viewed in the longitudinal direction of the opening. The second input section 14 is located on both sides of the opening 13 when viewed in the longitudinal direction thereof and located on the side of the display section where the display section is connected to the main body housing 2. The second input section 14 includes a second key input portion 16 constituted by two keys and a touch input portion 17 in the form of a touch panel. For example, the input method of the touch input portion 17 may be a method based on an electrostatic capacity or a method using a resistive film. An imaging window 18 exposing a lens section of the camera is provided near the touch input portion 17.

Further, a clear panel 19 is attached to the front plate 11 so as to cover the opening 13, the touch input portion 17, and the imaging window 18. The clear panel 19 is constituted by a transparent plate-like member. The clear panel 19 is formed with an exposing window 21. The exposing window 21 is disposed in a location associated with the second key input portion 16 when the clear panel 19 is attached to the front plate 11. The second key input portion 16 provided on the front plate 11 is exposed at the exposing window 21.

The rear plate 12 is provided in the form of a substantially rectangular plate. The rear plate 12 is disposed on the side of the display panel 10 opposite to side where the display surface 10a is provided, and the plate the entire rear surfaces of the front plate 11 and the display panel 10.

The rear plate 12 has a rear surface 12a formed in a substantially rectangular shape, two short edges 12b, a first long edge 12c, and a second long edge 12d surrounding the rear surface 12a. The two short edges 12b are located on two longitudinal ends of the rear surface 12a. The first long edge 12c is located one side of the rear surface 12a when viewed in the transverse direction of the rear surface, and the second long edge 12d is located on the other side of the rear surface 12a when viewed in the transverse direction of the rear surface. The hinge mechanism 4 is disposed on the side where the second long edge 12d is located.

FIG. 3 is a plan view of the notebook type personal computer 1 according to the present embodiment showing a closed state of the same. FIG. 4 is a side view of the notebook type personal computer 1 of the present embodiment, and FIG. 5 is a front view of the notebook type personal computer 1 of the present embodiment.

As shown in FIG. 3, the size of the rear surface 12a of the rear plate 12 is set substantially equal to the size of the main surface 2a of the main body housing 2. The corner portions of the rear surface 12a of the rear plate 12 on the side of the surface where the first long edge 12c is provided are cut into a round shape. The corner portions are formed smaller than the corner portions of the main surface 2a of the main body housing 2 on the side of the main surface opposite to the side where the hinge mechanism 4 is provided. Therefore, when the display section 3 is lapped over the main body housing 2, the corner portions of the main surface 2a are exposed out of the corner portions of the rear surface 12a of the rear plate 12 on the side of the rear surface where the first long edge 12c is provided.

As shown in FIGS. 4 and 5, a central part of the rear surface 12a of the rear plate 12 bulges in the direction opposite to the front plate 11, and a peripheral part of the surface is formed with roundness. Thus, a force acting on the rear plate 12 can be dispersed.

In the closed state of the apparatus, the display section 3 substantially entirely covers the main surface 2a of the main body housing 2 excluding the corner portions of the main surface. In this state, the first long edge 12c is substantially parallel to the front surface 2c of the main body housing 2, and the two short edges 12b are substantially parallel to the two side surfaces 2b of the main body housing 2. Thus, when the display section 3 is lapped over the main body housing 2, the side sections of neither the main body housing 2 nor the display section 3 protrude beyond the side section of the other. Therefore, the apparatus can formed with side sections and a front section which are substantially flat. As a result, when a user holds the notebook type personal computer 1 with a hand, the apparatus comfortably fits the hand of the user, and the apparatus main body can therefore be carried around with ease.

As shown in FIGS. 4 and 5, the surface area of the rear surface 12a of the rear plate 12 is set greater than the surface area of the front plate 11 on which the display panel 10 is provided. The peripheral part of the rear plate 12 bulges outwardly beyond the peripheral part of the front plate 11. Further, the lateral surfaces of the front plate 11 are tilted in such a direction that the area of the front plate 11 decreases from a value on the side thereof facing the rear plate 12 toward a value on the side thereof facing the main surface 2a of the main body housing 2. Therefore, when the display section 3 is lapped over the main body housing 2, a gap is formed between the display section 3 and the main body housing 2 on the side of the apparatus where the first long edge 12c of the rear plate 12 is located. As a result, a finger can be easily inserted at the first long edge 12c of the rear plate 12 to turn and open the display section 3.

Further, the first key input section 6 and the stick pointer 7 provided on the main surface 2a are entirely covered by the display section 3. Those elements will not be unintentionally operated by a user when the apparatus is carried around, and erroneous operations can therefore be prevented. Further, since the first key input section 6 and the stick pointer 7 are tightly covered by the display section 3, the display section 3 protects the first key input section 6 and the stick pointer 7 from dust and foreign substances. As a result, it is possible to prevent dust and foreign substances from accumulating at the key input section 6 and the stick pointer 7.

The present embodiment has been described as an example in which only the corner portions of the rear plate 12 on the side of the apparatus where the first long edge 12c of the rear surface 12a extends are made smaller than the respective corner portions of the main surface 2a of the main body housing 2. The invention is not limited to such a configuration. For example, all of the four corner portions of the rear surface 12a may be rounded such that the corner portions are smaller than the corner portions of the main surface 2a of the main body housing 2.

For example, engineering plastic may be used as the material of the rear plate 12 having the above-described configuration.

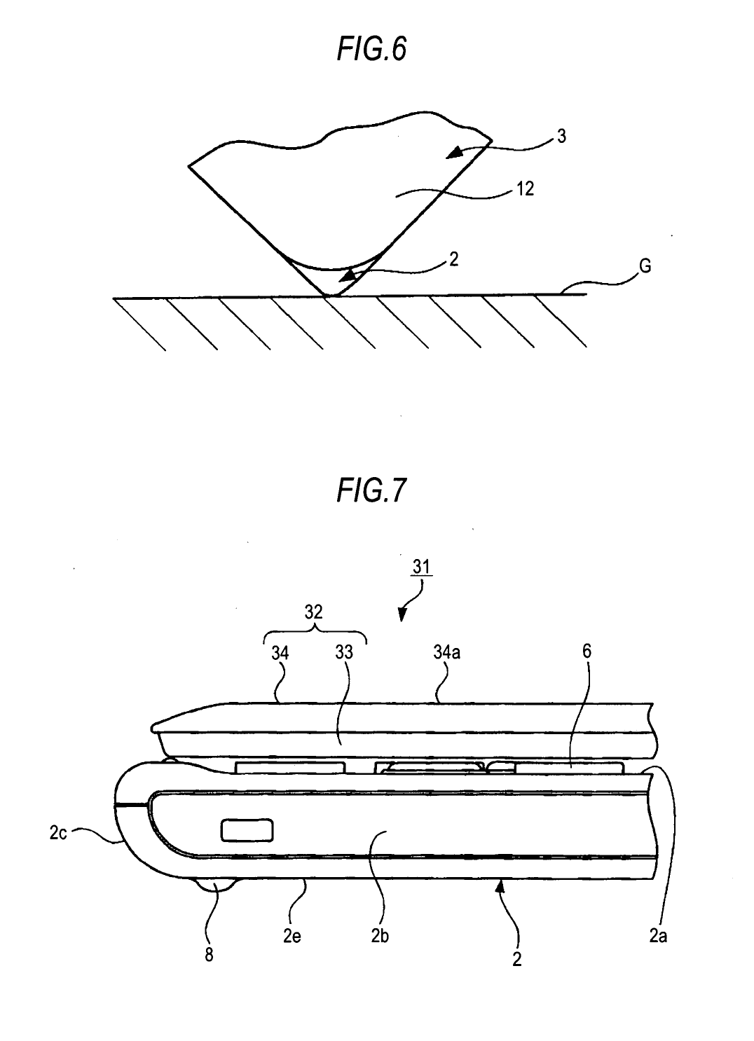

FIG. 6 is an illustration of a state of the notebook type personal computer 1 according to the embodiment of the invention observed when the computer is dropped into collision with the ground or a desk at a corner thereof.

As shown in FIG. 6, the corner portions of the display section 3 on the side thereof where the first long edge 12c of the rear plate 12 is located are formed smaller than the respective corner portions of the main body housing 2. Therefore, the corner portion of the main surface 2a of the main body housing 2 protrudes outwardly beyond the corner portion of the display section 3. That is, the corner portion of the display section 3 is located inwardly from the corner portion of the main surface 2a of the main body housing 2. Therefore, the corner portion of the display section 3 is less likely to collide with the ground (represented by “G”), and collision is more likely to occur at the corner portion of the main body housing 2 which is easier to reinforce and which is therefore higher in rigidity than the display section 3. Since the corner portion of the display section 3 is less likely to collide with the ground G, it is possible to prevent an impact force from being applied to the display section 3 which is difficult to reinforce. As a result, the breakage of the display panel 10 provided on the display section 3 can be prevented.

The rear plate 12 of the notebook type personal computer 1 is formed greater than the front plate 11 on which the display panel 10 is mounted. The peripheral part of the rear plate 12 bulges outwardly beyond the peripheral part of the front plate 11. Therefore, when the apparatus is dropped to the ground or a desk with a lateral section facing downward, the front plate 11 having the display panel 10 thereon is unlikely to collide with the ground or the desk. Thus, even when the apparatus is dropped to the ground or a desk with a lateral section thereof facing downward, it is possible to prevent a great impact force from being applied to the display panel 10, and the display panel 10 can therefore be protected from breakage attributable to an impact force.

Further, the display section 3 of the notebook type personal computer 1 of the present embodiment can be protected from an impact force imparted when the apparatus is dropped without reinforcing it with ribs. Therefore, the display section 3 can be provided with a small thickness and a light weight, and the notebook type personal computer 1 can be provided with high portability.

### 2. Second Embodiment

A second embodiment of a notebook type personal computer according to the present embodiment will now be described with reference to FIG. 7.

FIG. 7 is a side view of a notebook type personal computer 31 according to the second embodiment of the invention.

The notebook type personal computer 31 according to the second embodiment of the invention is different from the notebook type personal computer 1 according to the first embodiment in the shape of the display section. Therefore, the description will be focused on the display section, and an element which is commonly included in the second embodiment and the notebook type personal computer 1 of the first embodiment is indicated by the same reference numeral to avoid duplicated description.

As shown in FIG. 7, a display section 32 of the notebook type personal computer 31 includes a front plate 33 and a rear plate 34. The front plate 33 will not be described because it has the same configuration as that of the front plate 11 of the first embodiment.

The rear plate 34 is provided in the form of a substantially rectangular plate. The rear plate 34 entirely covers a rear side of the front plate 33. A central part of a rear surface 34a of the rear plate 34 bulges in the direction opposite to the front plate 33. The rear surface 34a of the rear plate 34 is sloped such that the thickness of the rear plate decreases from a value at the central part of the rear surface toward a value at a peripheral part thereof.

The configuration of the apparatus will not be further described because the configuration is otherwise similar to that of the above-described notebook type personal computer 1 according to the first embodiment. The notebook type personal computer 31 having the configuration as thus described provides effects and advantages similar to those of the above-described notebook type personal computer 1 according to the first embodiment.

The corner portion of the display section 32 of the notebook type personal computer 31 according to the second embodiment shown in the side view is inwardly inclined toward a main body housing 2. Thus, the peripheral part of the display section 32 has a small thickness, and the main body housing 2 is therefore more likely to collide with the ground, a desk or the like than the display section 32 when the apparatus is dropped. Thus, the display section 32 can be more effectively protected compared to the display section of the notebook type personal computer 1 according to the first embodiment.

The notebook type personal computer 31 according to the second embodiment has been described as having an exemplary configuration in which the profile of the corner portion of the display section 32 is inwardly inclined toward the main body housing 2. However, the invention is not limited to such a configuration. For example, the radius of curvature of the corner portion in the side view of the display section 32 may be set greater than the radius of curvature of a corner portion of the main body housing 2 at which a front surface 2c and a side surface 2b are connected with a mount surface 2e. That is, the intended effect can be achieved by forming the rear plate 34 of the display section such that its thickness decreases from a value at the central part toward a value at the peripheral part.

The invention is not limited to the embodiment described above and shown in the drawings, and various modifications may be made without departing from the spirit of the invention. For example, while the above embodiment has been described as an example in which a display section is connected to a main body housing such that the display section can be turned through a hinge mechanism, the invention is not limited to such a configuration, and the display section may be opened and closed by sliding it with respect to the main body housing.

The present application contains subject matter related to that disclosed in Japanese Priority Patent Application JP 2010-106903 filed in the Japan Patent Office on May 7, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A notebook type information processing apparatus comprising:
a main body housing having a substantially rectangular main surface on which an input section is disposed; and
a display section having a display panel and formed in a rectangular shape, the display section being lapped over the main surface of the main body housing, the display section covering the input section when lapped over the main body housing with a corner portion thereof disposed inwardly from a corner portion of the main surface to expose the corner portion of the main surface.

2. A notebook type information processing apparatus according to claim 1, wherein the thickness of the display section decreases from a value at a central part thereof toward a value at a peripheral part thereof.

3. A notebook type information processing apparatus according to claim 1 or 2, wherein
the display section has a front plate on which the display panel is provided and which faces the main surface of the main body housing and a rear plate which is disposed on a side of the display panel opposite to a display surface of the panel and to cover the front plate and a rear surface of the display panel;
the rear plate is formed greater than the front plate; and
a peripheral part of the rear plate bulges outwardly beyond a peripheral part of the front plate.

4. A notebook type information processing apparatus according to any of claims 1 to 3, wherein an edge of the display section and an edge of the main surface of the main body housing are substantially aligned in parallel with each other when the display section and the main body housing are viewed from above or from a rear side in the lapped state.

5. A notebook type information processing apparatus according to any of claims 1 to 4, wherein the corner portion of the display section is rounded.

6. A notebook type information processing apparatus according to any of claims 1 to 5, wherein
the display section is turnably connected to the main body housing through a hinge mechanism; and
the corner portion of the display section where the corner portion of the main surface of the main body housing is exposed is provided on both ends of an edge of the apparatus opposite to an edge where the hinge mechanism is provided.
